(19) United States
(12) Patent Application Publication
(10) Pub. No.: US 2002/0184195 A1
(43) Pub. Date: Dec. 5, 2002

(54) Integrating content from media sources

(76) Inventor: Richard J. Qian, Camas, WA (US)

Correspondence Address: FISH & RICHARDSON, PC, 4350 LA JOLLA VILLAGE DRIVE, SUITE 500, SAN DIEGO, CA, 92122, US

(21) Appl. No.: 09/870,867

(22) Filed: May 30, 2001

(51) Int. Cl. G06F 7/00

(52) U.S. Cl. 707/3

(57) ABSTRACT

Content is delivered from media sources by searching the media sources for content and metadata based on a search criteria, parsing the metadata from the sources, receiving user preference information from a user, integrating the content and the metadata according to the user preference information and based on the result of the parsing, and displaying an integrated content concurrently on one or more user displays.

### TECHNICAL FIELD

This invention relates to integrating content from media sources.

### BACKGROUND

Media sources include web pages, web broadcasts, and satellite and television broadcasts. Users who want to receive content from media sources generally search through the media looking for topics of interest.

Typically, searching is focused on one medium at a time. Searching for television programs, for example, may involve scanning a cable operator's listings on a channel devoted to listings or a satellite provider's listed programming guide. Even though some satellite operators group their listings by general topics, searches for a specific topic do not exist. In the case of the Internet, some websites (e.g., Yahoo) provide categories and subcategories on a wide range of topics with respect to content that is available on the Internet.

### DESCRIPTION OF DRAWINGS

FIG. 1 is a functional diagram of a multi-modal information integration system.

FIG. 2 is a representation of a user display.

FIG. 3 is a functional diagram of a description data manager.

FIG. 4 is a functional diagram of an information integrator.

FIG. 5 is a functional diagram of a multi-modal analysis engine.

FIG. 6 is a functional diagram of the multi-modal information integration system with an information presenter.

FIG. 7 is a functional diagram of the information presenter.

### DETAILED DESCRIPTION

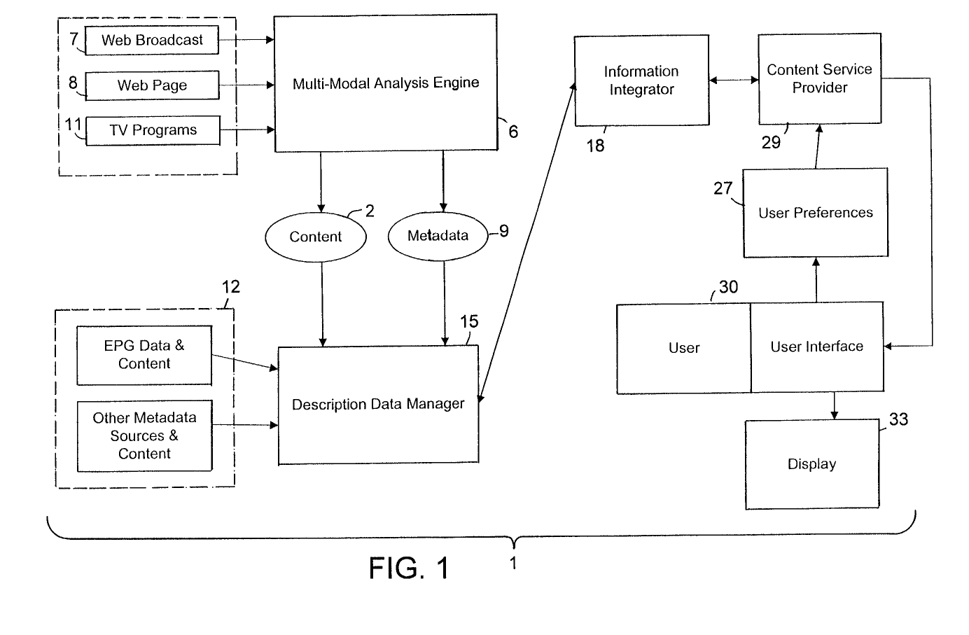

Referring to FIG. 1, a multi-modal information integration system 1 allows a user 30 to receive content from a variety of different media sources 3 and to have content seamlessly integrated on one or more displays 33 by topic without requiring the user 30 to switch back and forth among the media sources to access content.

System 1 allows the choice of content and the integration process to be personalized by the user 30. Also, the system allows for the integrated content to be accessible anytime from any location.

System 1 includes a description data manager 15 that parses metadata received from the different media sources in real-time and an information integrator 18 that integrates the parsed metadata and associated content from the data manager 15 for use by a content service provider 29. The user 30 receives the integrated content from the content service provider 29.

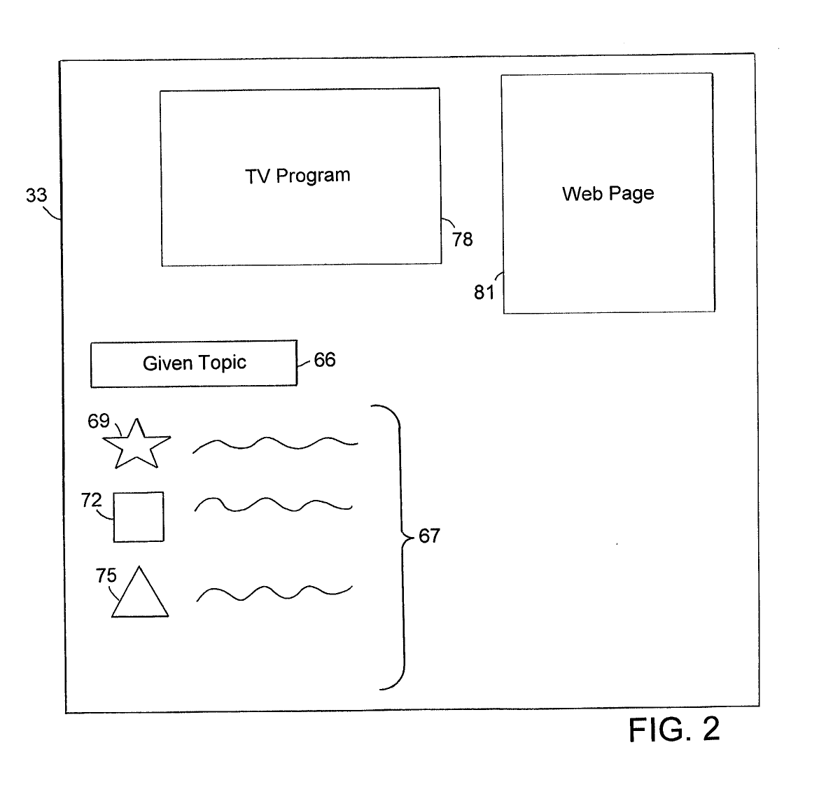

FIG. 2 depicts an example of what the user 30 observes on the display 33. A given topic 66 (for example, the Boston Red Sox) is displayed in text. Underneath the given topic 66, icons and/or a text description 67 represent the respective media sources, for example, a television (TV) program 69, a web page 72, and a broadcast 75. Choice of icons or text or positioning of them is controlled by the user preferences 27. User preferences 27 are generated by the user 30 and sent to the content service provider 29 and stored at the integrator 18. Each icon represents a source of content of a particular medium that has information available related to the selected topic. For example, the icon 69 could represent a TV program on channel 7 that related to the Boston Red Sox.

The user 30 would see the TV program 69 in a video window 78 and could simultaneously select a web page 75 (the home page of the Boston Red Sox, for example) and view the web page window 81 that contained information on the team.

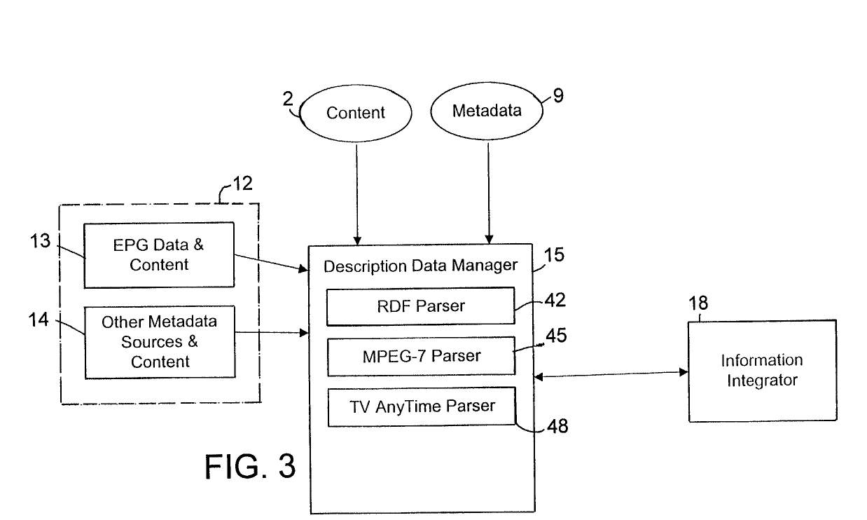

Referring to FIG. 3, for the purpose of parsing metadata, the data manager 15 receives metadata provided by outside metadata sources 12 along with the associated content. A metadata source would be an Electronic Programming Guide (EPG) 13 that is made available from some satellite TV providers and cable operators. For example, some cable operators have a channel that scrolls cable programs and times. EPG metadata includes a title, time of the broadcast, and a short description of the broadcast. Each body of content has an associated metadata description so that content associated with the EPG metadata would be the actual broadcast. Other metadata formats may be received including MPEG-7, a multimedia content description interface from the Movie Picture Experts Group (http://www.cselt.it/mpeq/), Resource Description Framework (RDF) from the World Wide Web Consortium (http: //www.w3.org/RDF/), and TV-AnyTime Specification which enables audio-visual and other services from the TV-Anytime Forum (http://www.tv-anytime.org/). Content and the metadata description are sent to the data manager 15.

The data manager 15 parses the metadata to generate a common set of descriptors. The data manager 15 parses metadata that has been expressed in different formats, using parsers for each of the formats, such as the RDF 42, MPEG-7 45 and TV-AnyTime 48 and translates them into a common set of descriptors that is recognizable by the information integrator 18. In other words, the data manager parser reads the stream of metadata for a format and looks for the descriptors within the format and translates them into common descriptors. For example, one formatted piece of metadata may have “movie title” as a descriptor and “Gone With The Wind” as its value and the corresponding common descriptor is called “title.”

The parser would convert the “movie title” descriptor to the common descriptor “title” and the “Gone With The Wind” value would then map to “title.” As long as the common descriptors chosen are recognizable by the information integrator 18, the common descriptors could be any existing format.

The parsed metadata and the associated content can be passed to the information integrator 18 in extensible markup language (XML), for instance or through an Application Programming Interface (API).

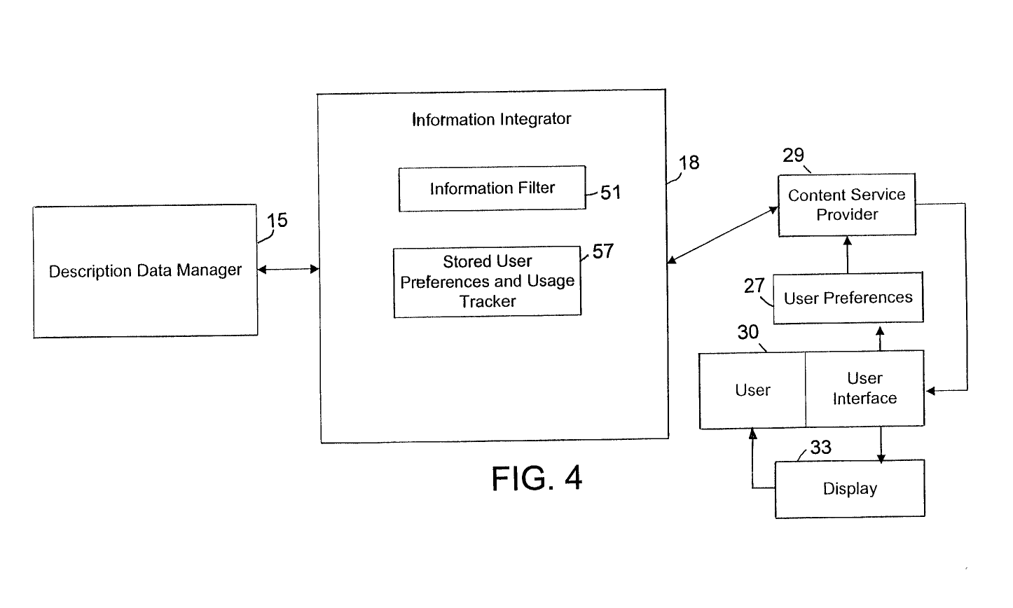

Referring to FIG. 4, the information integrator 18 includes an information filter 51 that filters out undesired content using stored user preferences 57 based on the user preferences 27 received from the content service provider 29. For example, if the user 30 wishes to receive only sports-related information, the integrator 18 would use the stored user preferences 57 to filter information relating to financial news.

Then, the information integrator 18 arranges content using the parsed metadata according to stored user preferences and usage tracking information 57. In one example, the integrator 18 arranges content by creating pointers that point to parts of content under the given topic heading. In another example, content is grouped into user-defined topics.

The stored user preferences and usage tracking information 57 also includes usage tracking information stored from past user actions. For example, the usage tracking information stores the number of times the user 30 selected a Uniform Resource Locator (URL) or the topics the user 30 has previously selected.

The integrator 18 uses the stored user preference and usage tracking information 57 to adapt and to prioritize content. For example, a user 30 may be prompted and queried whether the user 30 wants to see new information on a topic about which the user 30 has shown an interest in the past.

In another example, if the user 30 wants to receive sports-related information, he would choose which given topic headings to have displayed based on his user preferences 27, or the system determines it based on the usage tracking information 57. In the latter case, since the user 30 in the past looked at “golf” and “hockey” most of the time but looked at other sports intermittently, the integrator 18 would group all sports content related to “golf” under a given topic heading labeled “golf”, “hockey” under another given topic heading labeled hockey, and all other sports under a third given topic heading labeled “general.”

The integrated content from the integrator 18 can be accessed anytime. Integrated content can be stored at the content service provider 29 or cached by local storage of the client device by the user 30. After the integrator 18 sends the integrated content to the content service provider 29, the content service 29 provider supplies its customers with access to the given topics.

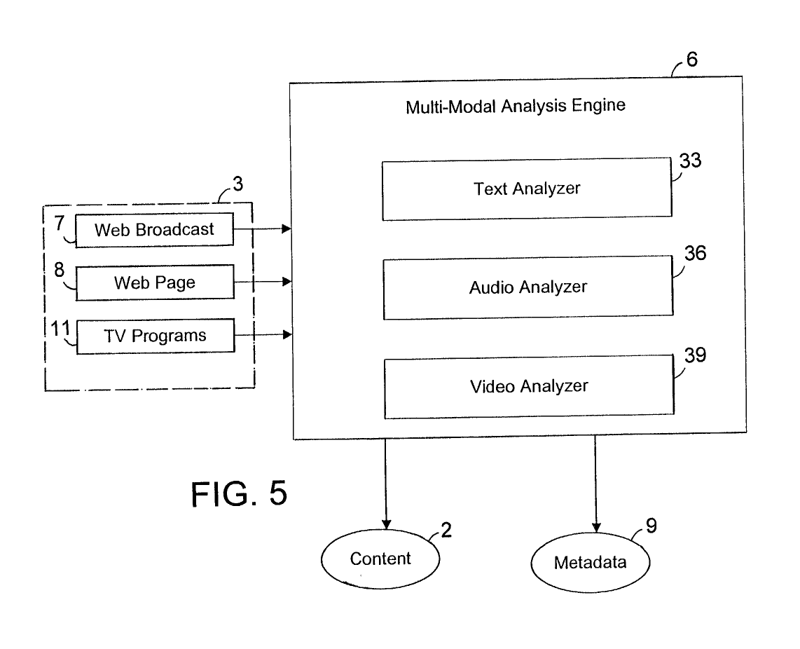

Referring to FIG. 5, another way that the description manager receives metadata is through a multi-modal analysis engine 6 that receives content and creates a corresponding metadata description 9 analogous to one provided by the metadata sources 12. The analysis engine 6 receives content from media sources 3 such as web broadcasts 7, web pages 8, and TV programs 11. The analysis engine 6 uses one or a combination of a text analyzer 33, an audio analyzer 36, or a video analyzer 39 to search through content. The analysis need not be limited to web pages 8, web broadcasts 7, and television programs 11. The analyzers gather all content that is available from the modal sources 3 and creates a metadata description that describes each piece of content gathered.

A standard text analyzer 33 may use a number of methods including statistical analysis of key words by frequency rate to gather content on any topic. A typical text analyzer would focus on key word frequency while eliminating superfluous words with excessive frequency.

For example, a search on given topic such as Mercury cars would have a key word such as “Sable” (a model of Mercury) while the amount of data for “car” or “automobile” would have a high frequency and would not be useful because content found would not all relate to Mercury cars. The text analyzer 33 may also be used with closed caption text to search TV programs for content.

The audio analyzer 36 searches through speech tracks from TV programs 11 or Web broadcasts 7 in a similar fashion as the text analyzer 33 and creates a metadata description for each piece of content gathered in a similar format as the metadata sources 12. Likewise, the video analyzer 39 searches web pages, web broadcasts and TV programs for images to create a metadata description similar to the one created by the text analyzer and in a similar format as the metadata sources. The analysis engine 6 sends content 2 and associated metadata description 9 to the data manager 15. While the content service provider 29 may use the analysis engine 6 to search all the media sources available, the content service provider 29 may adapt the analysis engine 6 to limit searches based on economic factors. For example, the content service provider 29 with limited financial resources may not be able to afford the storage capacity for large retrievals of content. The searches could then be limited to sources that offer the most useful information while eliminating extraneous sources.

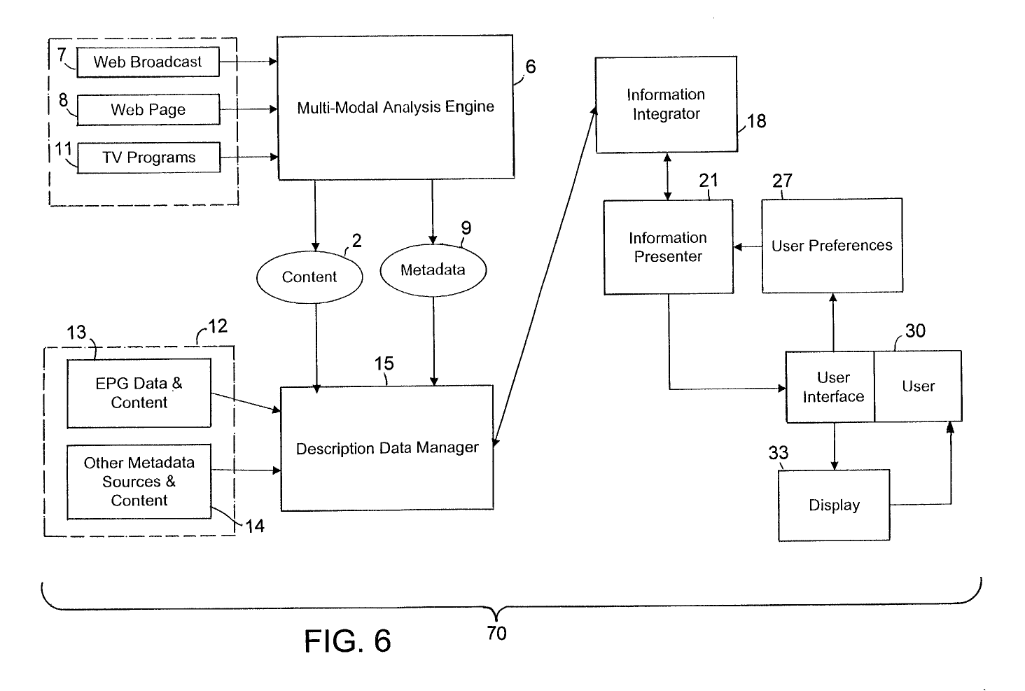

Referring to FIG. 6, system 1 can be adapted to bypass the content service provider 29 by adding an information presenter 21 on the backend to create a system 70. Individuals who do not want to go directly to a content service provider 29 can use system 70 for increased privacy or to meet needs the content service provider cannot meet. System 70 can be located in a business or in a home.

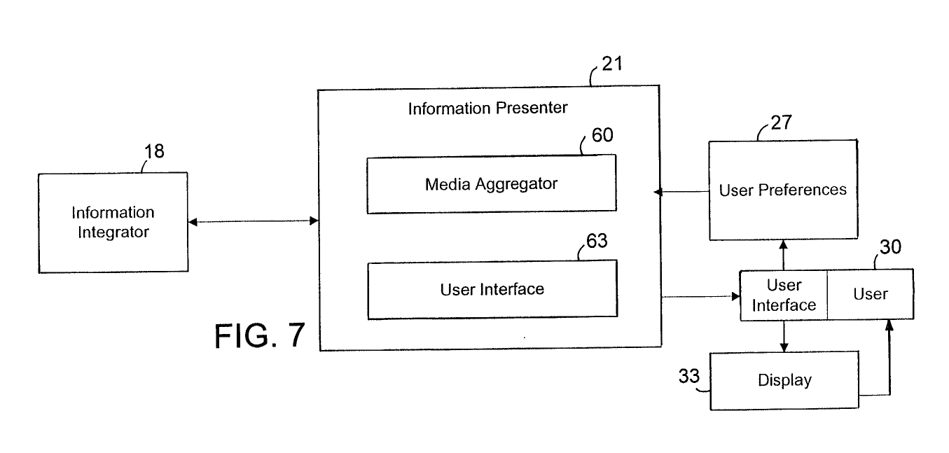

Referring to FIG. 7, in this configuration, the information integrator 18 passes the integrated information to the information presenter 21 instead of to the content service provider 29. The information presenter 21 aggregates the media for display in one space through a media aggregator 63.

For example, the television programs and the web pages are accessible on one screen for presentation concurrently without toggling between television and web pages. The media aggregator 60 is comprised of software or could be a combination of software with hardware display devices.

After the media is aggregated, the information presenter 21 transfers content through a user interface 63 to the user 30. Also, the information presenter receives the user preferences 27 from the user 30 to be stored under the stored user preferences 57 at the information integrator.

User 30 receives the integrated content through the content service provider 29 or the information presenter 21. The user 30 can display this content on a display device including but not limited to a handheld computer such as personal display assistants (PDA), set-top boxes, mobile phones or personal computers (PC) that have the necessary media capability required.

For example, both a full-motion video and a text story may be viewed concurrently on a PC with broadband connection while only text will be displayed on a PDA with a slow connection. The device capability profiles and different display choices can be expressed using emerging standards such as Composite Capabilities/Preference Profiles (CC/PP) from the World Wide Web Consortium (http://www.w3.org/Mobile/CCPP/) and Extensible Stylesheet Language (XSL) also from the World Wide Web Consortium (http://www.w3.org/Style/XSL/).

Alternative configurations would have the data manager 15 send only the parsed metadata without content to the information integrator 18. In this configuration, all content is stored at the data manager 15 for access anytime by the user 30. The data manager 15 arranges content by creating pointers that point to parts of content associated with the metadata. The parsed metadata would be passed to the user 30 and presented in a format based on user preferences 27.

Other embodiments are within the claims.

What is claimed is:

1. A method of integrating content from media sources comprising:
searching the media sources for content and metadata based on a search criteria;
parsing the metadata from the sources;
receiving user preference information from a user;
integrating the content and the metadata according to the user preference information and based on the result of the parsing; and
displaying an integrated content concurrently on one or more user displays.

2. The method of claim 1 further comprising providing the integrated content and the metadata to an information presenter.

3. The method of claim 1 further comprising providing the integrated content and the metadata resulting from the parsing to a content service provider.

4. The method of claim 1-wherein the sources comprise television programs, Internet broadcasts, and worldwide web pages.

5. The method of claim 1 wherein a data description manager passes the metadata resulting from the parsing and an associated content to an information integrator using an extensible markup language (XML).

6. The method of claim 1 wherein a data description manager passes the metadata resulting from the parsing and an associated content to an information integrator via an Application Programming Interface (API).

7. The method of claim 1 wherein the content is associated with one or more metadata descriptions.

8. The method of claim 7 wherein a multi-modal analysis engine creates the metadata description.

9. The method of claim 8 wherein the multi-modal analysis engine comprises a video analyzer, an audio analyzer, and a digital analyzer.

10. The method of claim 1 further comprising storing the integrated content for access at anytime by the user.

11. An apparatus for delivering content from media sources, comprising:
a memory that stores executable instructions; and
a processor that executes the instructions to:
search the media sources for content and metadata based on a search criteria;
parse the metadata from the sources;
receive user preference information from a user;
integrate the content and the metadata according to the user preference information and based on the result of the parsing; and
display an integrated content concurrently on one or more user displays.

12. The apparatus of claim 11 wherein the processor executes instructions further comprising providing the integrated content to an information presenter.

13. The apparatus of claim 11 wherein the processor executes instructions further comprising providing the integrated content to a content service provider.

14. The apparatus of claim 11 wherein the sources comprise television programs, Internet broadcasts, and worldwide web pages.

15. The apparatus of claim 11 wherein a data description manager passes the metadata resulting from the parsing and an associated content to an information integrator using an extensible markup language (XML).

16. The apparatus of claim 11 wherein a data description manager passes the metadata resulting from the parsing and an associated content to an information integrator via an Application Programming Interface (API)

17. The apparatus of claim 11 wherein the content is associated with one or more metadata descriptions.

18. The apparatus of claim 17 wherein a multi-modal analysis engine creates the metadata description.

19. The apparatus of claim 18 wherein the multi-modal analysis engine comprises a video analyzer, an audio analyzer, and a digital analyzer.

20. The apparatus of claim 11 wherein the processor executes instructions further comprising storing the integrated content for access at anytime by the user.

21. An article comprising a computer-readable medium that stores executable instructions for delivering content from media sources, the instructions causing a machine to:
search the media sources for content and metadata based on a search criteria;
parse the metadata from the sources;
receive user preference information from a user;
integrate the content and the metadata according to the user preference information and based on the result of the parsing;
display an integrated content concurrently on one or more user displays.

22. The article of claim 21 further comprising instructions causing the machine to provide the integrated content to an information presenter.

23. The article of claim 21 further comprising instructions causing the machine to provide the integrated content to a content service provider.

24. The article of claim 21 wherein the sources comprise television programs, Internet broadcasts, and worldwide web pages.

25. The article of claim 21 wherein a data description manager passes the metadata resulting from the parsing and an associated content to an information integrator using an extensible markup language (XML).

26. The article of claim 21 wherein a data description manager passes the metadata resulting from the parsing and an associated content to an information integrator via an Application Programming Interface (API).

27. The article of claim 21 wherein the content is associated with one or more metadata descriptions.

28. The article of claim 27 wherein a multi-modal analysis engine creates the metadata description.

29. The article of claim 28 wherein the multi-modal analysis engine comprises a video analyzer, an audio analyzer, and a digital analyzer.

30. The article of claim 21 further comprising instructions causing the machine to store the integrated content for access at anytime by the user.
